(19) United States
(12) Patent Application Publication
(10) Pub. No.: US 2024/0337978 A1
(43) Pub. Date: Oct. 10, 2024

(54) IMAGE FORMING SYSTEM, IMAGE FORMING METHOD, AND CRIMPING TONER IMAGE FORMING APPARATUS

(71) Applicant: FUJIFILM Business Innovation Corp., Tokyo (JP)

(72) Inventors: Masahiko KUBO, Kanagawa (JP); Tomokazu KURITA, Kanagawa (JP); Takeharu NAGAI, Kanagawa (JP)

(73) Assignee: FUJIFILM Business Innovation Corp., Tokyo (JP)

(21) Appl. No.: 18/610,299

(22) Filed: Mar. 20, 2024

(30) Foreign Application Priority Data
Apr. 10, 2023 (JP) 2023-063298

(51) Int. Cl. G03G 15/00; G03G 9/08; G03G 15/01

(52) U.S. Cl. CPC G03G 15/6585; G03G 9/0819; G03G 15/0126; G03G 15/0189; G03G 15/6544; G03G 2215/00835

(57) ABSTRACT

An image forming system includes an image forming unit that forms an image on a recording medium by using a color toner, an applying unit that applies a crimping toner having pressure-responsiveness onto at least a portion of a surface of the recording medium on which the image is formed, a heating unit that heats the crimping toner applied to the recording medium, and a pressurizing unit that pressurizes, in a thickness direction, a stacked body in which the recording medium is folded with the heated crimping toner interposed or a stacked body in which the recording medium and another medium are stacked with the heated crimping toner interposed, in which a volume average particle diameter of the crimping toner is more than a volume average particle diameter of the color toner.

### CROSS-REFERENCE TO RELATED APPLICATIONS

This application is based on and claims priority under 35 USC 119 from Japanese Patent Application No. 2023-063298 filed Apr. 10, 2023.

### BACKGROUND

### (i) Technical Field

The present invention relates to an image forming system, an image forming method, and a crimping toner image forming apparatus.

### (ii) Related Art

Crimped printed matters (for example, crimped postcards and the like) that are printed matters formed by folding a recording medium such as paper and adhering facing surfaces to each other, or printed matters formed by stacking a recording medium and another medium and adhering facing surfaces to each other are known. A crimping toner capable of exerting a crimping function for adhering a medium in producing such crimped printed matters has been proposed.

For example, JP2021-18422A discloses a method of manufacturing a crimped printed matter in a manner that, for example, a crimping toner and the like are used as pressure-responsive particles that perform phase transition by applying pressure and exhibit adhesiveness, and the pressure-responsive particles are applied onto a surface of a recording medium and heating is performed, and then a stacked body in which a recording medium is folded with the heated pressure-responsive particles interposed, or a stacked body in which a recording medium and another medium are stacked with the heated pressure-responsive particles interposed is pressurized in a thickness direction.

The crimping toner is excellent in environmental performance and labor saving in a post-processing workflow as compared with a technique of performing adhering with a UV varnish that is cured by UV light or the like in the related art, but has a problem of low adhesive strength.

### SUMMARY

Aspects of non-limiting embodiments of the present disclosure relate to an image forming system, an image forming method, and a crimping toner image forming apparatus in which adhesive strength of a crimping toner is improved as compared with a case where a volume average particle diameter of the crimping toner is equal to or less than a volume average particle diameter of a color toner.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming system including an image forming unit that forms an image on a recording medium by using a color toner, an applying unit that applies a crimping toner having pressure-responsiveness onto at least a portion of a surface of the recording medium on which the image is formed, a heating unit that heats the crimping toner applied to the recording medium, and a pressurizing unit that pressurizes, in a thickness direction, a stacked body in which the recording medium is folded with the heated crimping toner interposed or a stacked body in which the recording medium and another medium are stacked with the heated crimping toner interposed, in which a volume average particle diameter of the crimping toner is more than a volume average particle diameter of the color toner.

### BRIEF DESCRIPTION OF THE DRAWINGS

Exemplary embodiment(s) of the present invention will be described in detail based on the following figures, wherein:

FIG. 1 is a schematic configuration view showing an example of an image forming system according to an exemplary embodiment of the present invention;

FIGS. 2A and 2B are schematic views showing a difference in image structure and adhesive strength due to a difference in particle diameter between the crimping toner and the color toner; and

FIG. 3 is a schematic view of a surface in Example 1 (right in FIG. 3) and in Example 4 (left in FIG. 3) before a heating step and a pressurizing step of a crimping toner, a schematic view of a cross section after the heating step and a pressurizing step, and a schematic view showing a form of the crimping toner in the pressurizing step.

### DETAILED DESCRIPTION

Hereinafter, an exemplary embodiment of the present invention will be described. The present exemplary embodiment is an example in which the present invention is implemented, and the present invention is not limited to the present exemplary embodiment.

Regarding the ranges of numerical values described in stages in the present exemplary embodiment, the upper limit value or lower limit value in a range of numerical values may be replaced with the upper limit value or lower limit value in another range of numerical values described in stages. In the numerical range described in the present disclosure, an upper limit value or a lower limit value of the numerical range may be replaced with value described in the examples.

In the present exemplary embodiment, the term “step” includes not only an independent step but also a step that cannot be clearly distinguished from other steps but can achieve the expected object thereof.

In the present exemplary embodiment, in a case where the exemplary embodiment is described with reference to drawings, the configuration of the exemplary embodiment is not limited to the configuration shown in the drawings. The size of the member in each drawing is conceptual, and the relative relationship between the sizes of the members is not limited to the illustrations.

In the present exemplary embodiment, each component may include two or more types of corresponding substances. In a case where the amount of each component in a composition is mentioned in the present exemplary embodiment, and there are two or more kinds of substances corresponding to each component in the composition, unless otherwise specified, the amount of each component means the total amount of two or more kinds of the substances present in the composition.

In the present exemplary embodiment, a plurality of types of crimping toners may be provided. In a case where a plurality of types of crimping toners are contained in a composition, the particle diameter of the crimping toner (for example, volume average particle diameter) means a value for a mixture of the plurality of types of crimping toners, unless otherwise specified.

In the present exemplary embodiment, the term “(meth)acryl” may denote any of “acryl” or “methacryl”.

In the present exemplary embodiment, a printed matter formed by folding a recording medium and adhering facing surfaces to each other, or a printed matter formed by stacking two or more media such as a recording medium and another medium and adhering facing surfaces to each other is referred to as a “crimped printed matter”.

In the present exemplary embodiment, “peeling strength” is an index indicating the degree of peeling between the facing surfaces of the recording medium, and is substantially synonymous with “adhesiveness” indicating the degree of adhesion. The “peeling strength” simply referred to as indicates peeling strength between the facing surfaces of a recording medium or between the facing surfaces of a recording medium and another medium. In addition, the “adhesiveness” simply referred to as indicates adhesiveness between the facing surfaces of a recording medium or between the facing surfaces of a recording medium and another medium.

### Image Forming System and Image Forming Method

An image forming system according to the present exemplary embodiment includes an image forming unit that forms an image on a recording medium by using a color toner, an applying unit that applies a crimping toner having pressure-responsiveness onto at least a portion of a surface of the recording medium on which the image is formed, a heating unit that heats the crimping toner applied to the recording medium, and a pressurizing unit that pressurizes, in a thickness direction, a stacked body in which the recording medium is folded with the heated crimping toner interposed or a stacked body in which the recording medium and another medium are stacked with the heated crimping toner interposed, in which a volume average particle diameter of the crimping toner is more than a volume average particle diameter of the color toner. The image forming system according to the present exemplary embodiment may further include a special color image forming unit that forms a special color image on a recording medium by using a special color toner.

An image forming method according to the present exemplary embodiment includes an image forming step of forming an image on a recording medium by using a color toner, an applying step of applying a crimping toner having pressure-responsiveness onto at least a portion of a surface of the recording medium on which the image is formed, a heating step of heating the crimping toner applied to the recording medium, and a pressurizing step of pressurizing, in a thickness direction, a stacked body in which the recording medium is folded with the heated crimping toner interposed or a stacked body in which the recording medium and another medium are stacked with the heated crimping toner interposed, in which a volume average particle diameter of the crimping toner is more than a volume average particle diameter of the color toner. The image forming method according to the present exemplary embodiment may further include a special color image forming step of forming a special color image by using a special color toner as a recording medium.

An applying device as the applying unit that applies a crimping toner by an electrophotographic method includes an image holding member, a charging unit that charges a surface of the image holding member, an electrostatic charge image forming unit that forms an electrostatic charge image on the charged surface of the image holding member, a developing unit that accommodates an electrostatic charge image developer containing a crimping toner and develops the electrostatic charge image formed on the surface of the image holding member as a crimping toner application portion, with the electrostatic charge image developer, and a transfer unit that transfers the crimping toner application portion formed on the surface of the image holding member to a surface of a recording medium. An application region of the crimping toner is referred to as a “crimping toner application portion” for convenience.

An applying step of applying the crimping toner by an electrophotographic method includes a charging step of charging the surface of the image holding member, an electrostatic charge image forming step of forming an electrostatic charge image on the charged surface of the image holding member, a developing step of developing an electrostatic charge image formed on the surface of the image holding member as a crimping toner application portion, with an electrostatic charge image developer containing a crimping toner, and a transfer step of transferring the crimping toner application portion formed on the surface of the image holding member to a surface of a recording medium.

In the applying device, a portion including the developing unit may be a cartridge structure that is detachably attached to the applying device, that is, a so-called process cartridge. As the process cartridge, for example, a process cartridge that includes a developing unit that accommodates an electrostatic charge image developer containing a crimping toner and is detachably attached to the applying device is preferably used.

Both the applying devices and applying step described above correspond to an electrophotographic image forming apparatus and an electrophotographic image forming method. Therefore, the known unit and the known step adopted in the electrophotographic image forming apparatus and the electrophotographic image forming method may be used as all of each unit in the applying device and each step in the applying step.

An intermediate transfer method may be adopted for the applying device and the applying step. The crimping toner application portion formed on the surface of the image holding member is once transferred to the surface of an intermediate transfer member, and then, finally, transferred from the surface of the intermediate transfer member to the surface of the recording medium.

The applying device and the applying step may include, for example, units or steps other than the above description, such as a step and a unit of performing cleaning of the surface of the image holding member, and a device including an erasing unit that performs erasing by irradiating the surface of the image holding member with erasing light, and the like.

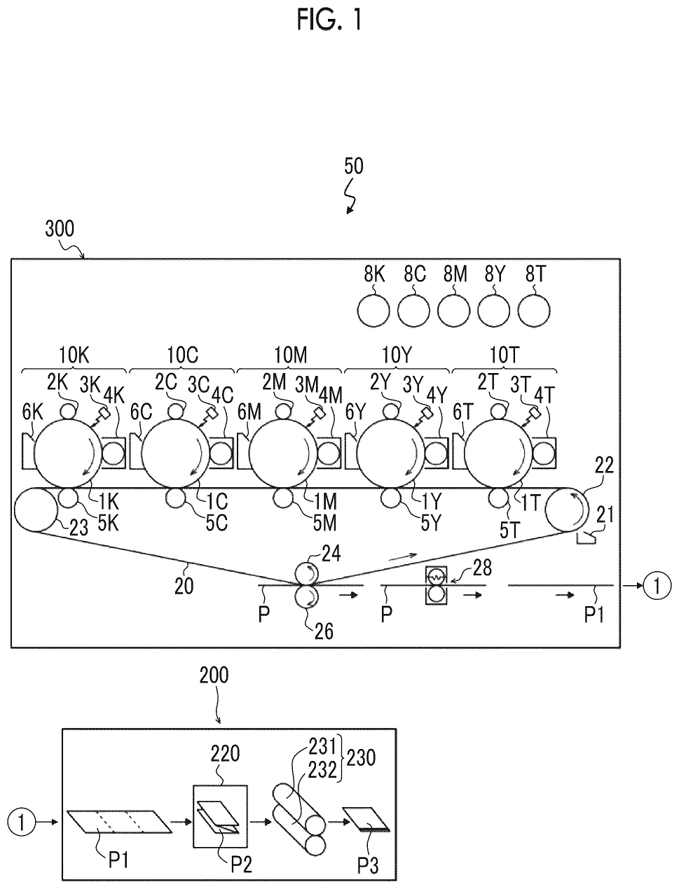

FIG. 1 shows an outline of an example of the image forming system according to the exemplary embodiment of the present invention, and a configuration and an operation of the image forming system will be described. The present exemplary embodiment is not limited to this.

An image forming system 50 shown in FIG. 1 includes an image forming unit, an applying unit, and a heating device 28 as a heating unit. The image forming unit forms an image on at least a portion of a surface of a recording medium P by using a color toner. The applying unit applies a crimping toner having pressure-responsiveness onto at least a portion of the surface of the recording medium P. The heating unit heats the crimping toner applied to the recording medium P. The image forming system 50 also includes an image forming apparatus 300 that collectively performs image formation and application of the crimping toner and a crimping apparatus 200 disposed on a downstream side of the image forming apparatus 300. The crimping apparatus 200 includes a pressurizing device 230 as the pressurizing unit that pressurizes, in the thickness direction, a stacked body formed by folding a recording medium P1 to which the crimping toner has been applied, with the heated crimping toner interposed or a stacked body obtained by stacking the recording medium P1 to which the crimping toner has been applied and another medium with the heated crimping toner interposed. The image forming system 50 may include a stacking device 220 that folds a recording medium P1 with the heated crimping toner interposed, or stacks a recording medium P1 and another medium with the heated crimping toner interposed. An arrow shown for the recording medium P in FIG. 1 indicates a transport direction of the recording medium P.

The image forming apparatus 300 is, for example, a 5-series tandem type and intermediate transfer type image forming unit. The image forming apparatus 300 includes, for example, a unit 10T that applies a crimping toner having pressure-responsiveness, and units 10Y, 10M, 10C, and 10K that form an image by using color toners of the respective colors being yellow (Y), magenta (M), cyan (C), and black (K), and the like. The unit 10T is an applying unit that applies the crimping toner onto the recording medium P by using an electrostatic charge image developer containing the crimping toner having pressure-responsiveness. Each of the units 10Y, 10M, 10C, and 10K is an image forming unit that forms a color image on the recording medium P by using the electrostatic charge image developer containing the color toner. The units 10T, 10Y, 10M, 10C, and 10K adopts an electrophotographic method. A unit similar to the above unit may be further provided as a special color image forming unit that forms a special color image by using a special color toner.

The units 10T, 10Y, 10M, 10C, and 10K are arranged, for example, to be spaced apart from each other in the horizontal direction. The units 10T, 10Y, 10M, 10C, and 10K may be process cartridges that are detachable from the image forming apparatus 300.

An intermediate transfer belt (an example of an intermediate transfer member) 20 passing through the units 10T, 10Y, 10M, 10C, and 10K is provided below the units 10T, 10Y, 10M, 10C, and 10K to extend. The intermediate transfer belt 20 is provided, for example, to be looped around a driving roll 22, a support roll 23, and an opposing roll 24 that are in contact with the inner surface of the intermediate transfer belt 20, and runs toward the unit 10K from the unit 10T. An intermediate transfer member cleaning device 21 facing the driving roll 22 is provided on the side of an image holding surface of the intermediate transfer belt 20.

The units 10T, 10Y, 10M, 10C, and 10K include developing devices (an example of the developing unit) 4T, 4Y, 4M, 4C, and 4K, respectively. The crimping toner, the yellow toner, the magenta toner, the cyan toner, and the black toner contained in a cartridge or the like are supplied to the developing devices 4T, 4Y, 4M, 4C, and 4K, respectively.

Since the units 10T, 10Y, 10M, 10C, and 10K have equivalent configurations and operations, the unit 10T that applies the crimping toner onto the recording medium will be described as a representative.

The unit 10T includes a photoconductor (an example of the image holding member) 1T. Around the photoconductor 1T, a charging roll (an example of a charging unit) 2T, an exposure device (an example of the electrostatic charge image forming unit) 3T, a developing device (an example of the developing unit) 4T, a primary transfer roll (an example of a primary transfer unit) 5T, and a photoconductor cleaning device (an example of the cleaning unit) 6T are disposed in order. The charging roll 2T charges the surface of the photoconductor 1T. The exposure device 3T exposes the charged surface of the photoconductor IT with a laser light beam to form an electrostatic charge image. The developing device 4T supplies the crimping toner to the electrostatic charge image and develops the electrostatic charge image as a crimping toner application portion. The primary transfer roll 5T transfers the developed crimping toner application portion onto the intermediate transfer belt 20. The photoconductor cleaning device 6T removes the crimping toner remaining on the surface of the photoconductor IT after the primary transfer. The primary transfer roll 5T is disposed on the inner side of the intermediate transfer belt 20 and is provided at a position facing the photoconductor 1T.

Operations of performing application of the crimping toner (applying step) and image formation (image forming step) on the recording medium P will be described below while describing an operation of the unit 10T.

First, the surface of the photoconductor IT is charged by the charging roll 2T. The exposure device 3T irradiates the charged surface of the photoconductor IT with a laser light beam, in accordance with image data transmitted from a control unit (not shown). As a result, an electrostatic charge image as an application region of the crimping toner is formed on the surface of the photoconductor 1T.

As the photoconductor IT runs, the electrostatic charge image formed on the photoconductor 1T rotates to a developing position. At the developing position, the electrostatic charge image on the photoconductor IT is developed by the developing device 4T and turns into the crimping toner application portion.

For example, an electrostatic charge image developer containing at least the crimping toner and a carrier is accommodated in the developing device 4T. The crimping toner is frictionally charged by being agitated together with the carrier inside the developing device 4T, and is held on a developer roll. As the surface of the photoconductor IT passes through the developing device 4T, the crimping toner is electrostatically stuck to the electrostatic charge image on the surface of the photoconductor 1T, and the electrostatic charge image is developed by the crimping toner. The photoconductor IT on which the crimping toner application portion is formed with the crimping toner continues to run, and the crimping toner application portion developed on the photoconductor IT is transported to a primary transfer position.

In a case where the crimping toner application portion on the photoconductor IT is transported to the primary transfer position, primary transfer bias is applied to a primary transfer roll 5T, and the electrostatic force directed to the primary transfer roll 5T from the photoconductor 1T acts on the crimping toner application portion. As a result, the crimping toner application portion on the photoconductor IT is transferred onto the intermediate transfer belt 20. The crimping toner remaining on the photoconductor IT is removed by the photoconductor cleaning device 6T and collected. The photoconductor cleaning device 6T is, for example, a cleaning blade, a cleaning brush, or the like. The photoconductor cleaning device 6T is preferably a cleaning brush, for example.

The same operation as the operation of the unit 10T is performed in the units 10Y, 10M, 10C, and 10K, for example, by using an electrostatic charge image developer containing a color toner and a carrier. The intermediate transfer belt 20 to which the crimping toner application portion of the crimping toner is transferred by the unit 10T sequentially passes through the units 10Y, 10M, 10C, and 10K, and color toner images of the respective colors are transferred onto the intermediate transfer belt 20 in a multiple manner.

The intermediate transfer belt 20, to which the crimping toner application portion and the color toner images are transferred in layers through the units 10T, 10Y, 10M, 10C, and 10K, reaches a secondary transfer portion configured with the intermediate transfer belt 20, an opposing roll 24 in contact with the inner surface of the intermediate transfer belt, and a secondary transfer roll (an example of a secondary transfer unit) 26 disposed on the image holding surface side of the intermediate transfer belt 20. On the other hand, the recording medium P is supplied, via a supply mechanism, to a gap between the secondary transfer roll 26 and the intermediate transfer belt 20 that are in contact with each other, and a secondary transfer bias is applied to the opposing roll 24. At this time, an electrostatic force directed from the intermediate transfer belt 20 toward the recording medium P acts on the crimping toner application portion and the color toner image, and the crimping toner application portion and the color toner image on the intermediate transfer belt 20 are transferred onto the recording medium P.

The recording medium P to which the crimping toner application portion and the color toner image are transferred is transported to the heating device (an example of the heating unit) 28 and then heated (heating step). By being heated by the heating device 28, the color toner image is thermally fixed on the recording medium P, and the crimping toner application portion with the crimping toner is heated, and thus plasticization of the crimping toner is accelerated.

The heating device 28 that heats the crimping toner is not particularly limited, and may be any unit that can heat the crimping toner applied on the recording medium. The heating device 28 may be a contact type or a non-contact type. Examples of the contact type heating method include a method of heating members such as rolls, belts, pads, and the like, and bringing the heated members into contact with the crimping toner, and the like. Examples of the non-contact type heating method include a method of causing a recording medium to which the crimping toner is applied to pass through a region heated by a heater, an oven, or the like, and a method of heating the crimping toner by irradiation light from a halogen lamp, a xenon lamp, or the like.

Among the above methods, from the viewpoint of heating the crimping toner and suppressing the movement, dropping, and the like of the crimping toner, for example, it is preferable to use a contact-type heating method. That is, the heating device 28 is preferably, for example, a contact-type heating unit.

In a case where the crimping toner is heated by the contact method, a setting temperature of a member (also referred to as a contact member) brought into contact with the crimping toner may be a temperature at which the crimping toner can be plasticized. From the viewpoint of heating efficiency of the crimping toner and the like, for example, a range of 120° C. or higher and 250° C. or lower may be set, a range of 130° C. or higher and 200° C. or lower is preferable, and a range of 150° C. or higher and 180° C. or lower is more preferable. Here, the setting temperature of the contact member refers to a target value of a surface temperature of the contact member, which comes into contact with the crimping toner.

The surface temperature of the recording medium P heated by the heating device 28 is, for example, 10° C. or higher and 80° C. or lower, preferably 20° C. or higher and 60° C. or lower, and more preferably 30° C. or higher and 50° C. or lower.

The contact member is not particularly limited as long as the contact member has a surface heated to the above-described setting temperature, and examples of the contact member include a roll, a belt, a pad, and the like.

From the viewpoint of suppressing dropping of the crimping toner from the recording medium P, improving fixability of the color toner to the recording medium P, and accelerating plasticization of the crimping toner, the heating device 28 is preferably, for example, a device that performs pressurization together with heating (also referred to as a heating and pressurizing device). By heating and pressurizing the crimping toner, smoothness is imparted to the surface to which the crimping toner is applied (for example, the surface of a crimping toner layer).

The unit that heats and pressurizes the crimping toner (also referred to as a heating and pressurizing member) includes examples as follows. That is, there are heating and pressurizing roll pairs that are two contacting roll pairs, in which heat is applied from at least one roll of the pairs, and a recording medium to which the crimping toner has been applied is inserted into a space between the roll pairs, and is heated and pressurized, a heating and pressurizing member that is a member in which a roll and a belt are in contact with each other, the heating and pressurizing member in which heat is applied from at least one of the roll and the belt, and a recording medium to which the crimping toner has been applied is inserted into a space between the roll and the belt, and is heated and pressurized, heating and pressurizing belt pairs that are two contacting belt pairs, in which heat is applied at least one belt of the pairs, and a recording medium to which the crimping toner has been applied is inserted into a space between the belt pairs, and is heated and pressurized, and the like.

In a case where the heating device 28 is a heating and pressurizing device, for example, it is preferable that the heating device 28 includes a heating source such as a halogen heater or the like and includes a roll pair that come into contact with the crimping toner application portion on the recording medium P and the color toner image and heats the crimping toner application portion and the color toner image. By causing the recording medium having the crimping toner application portion and the color toner image to pass between the roll pairs, the color toner image is thermally fixed on the recording medium P, the crimping toner application portion with the crimping toner is heated, and plasticization of the crimping toner is accelerated.

In a case where the heating device 28 performs heating and pressurizing, the pressure applied to the recording medium P by a heating and pressurizing member may be lower than the pressure applied to a recording medium P2 by the pressurizing device 230.

In this manner, the recording medium P becomes the recording medium P1 on which a color image is formed and the crimping toner is applied, by passing through the image forming apparatus 300. Then, the recording medium P1 is transported toward the crimping apparatus 200 and is pressurized (pressurizing step).

In the image forming system 50 according to the present exemplary embodiment, the image forming apparatus 300 and the crimping apparatus 200 may be close to each other or may be separated from each other. In a case where the image forming apparatus 300 and the crimping apparatus 200 are separated from each other, the image forming apparatus 300 and the crimping apparatus 200 may be joined to each other by, for example, a transport unit (for example, a belt conveyor) that transports the recording medium P1.

The crimping apparatus 200 includes, for example, the stacking device 220 and the pressurizing device 230. In the crimping apparatus 200, the pressurizing device 230 pressurizes, in the thickness direction, a stacked body in a manner that the stacking device 220 folds the recording medium P1 to which the crimping toner has been applied, with the heated crimping toner interposed, or the stacking device 220 stacks the recording medium P1 to which the crimping toner has been applied and another medium with the heated crimping toner interposed.

The stacking device 220 produce an overlapping recording medium (that is, a stacked body) P2 by folding the recording medium P1 passing through the stacking device 220, or stacking the recording medium P1 passing through the stacking device 220 and another medium. In the recording medium (that is, the stacked body) P2 obtained by the stacking device 220, the crimping toner applied by the image forming apparatus 300 is disposed at at least a portion of at least one surface of two facing surfaces of the recording medium or two facing surfaces of the recording medium and another medium.

The recording medium P2 may be folded, for example, in half, thirds, quarters, or the like. Furthermore, only a part of the recording medium P2 may be folded.

Examples of a form in which the recording medium P1 and another recording medium are stacked together include a form in which one sheet of another recording medium is stacked on the recording medium P1, and a form in which one sheet of another recording medium is stacked on a plurality of sites on the recording medium P1, and the like. This another medium may be, for example, a recording medium having an image formed in advance on one surface or both surfaces thereof, a recording medium with no image, or a crimped printed matter prepared in advance.

The stacking device 220 may have a pair of pressurizing members (for example, roll/roll or belt/roll) that applies pressure to the recording medium P2. The pressure applied to the recording medium P2 by the pressurizing member of the stacking device 220 may be lower than the pressure applied to the recording medium P2 by the pressurizing device 230.

The recording medium P2 passing through the stacking device 220 is transported to the pressurizing device 230.

The pressurizing device 230 is not particularly limited as long as the pressurizing device 230 is a unit that can pressurize the stacked body in the thickness direction, may be a unit that inserts the stacked body between roll pairs spaced apart from each other, or may be a unit that pressurizes the stacked body by a pressing machine or the like.

The pressurizing device 230 includes, for example, a pair of pressurizing members (that is, a pressurizing roll 231 and a pressurizing roll 232) such as a roll pair or the like. The pressurizing roll 231 and the pressurizing roll 232 are spaced apart from each other, for example, at a distance C. The pressurizing roll 231 and the pressurizing roll 232 come into contact with each other and are pressed against each other on the outer peripheral surfaces of the pressurizing roll 231 and the pressurizing roll 232, and a recording medium (that is, the stacked body) P2 is caused to pass between the roll pairs, thereby applying pressure in the thickness direction of the recording medium P2. The pair of pressurizing members in the pressurizing device 230 is not limited to the combination of pressurizing rolls, and may be a combination of a pressurizing roll and a pressurizing belt or a combination of pressurizing belts.

Here, the distance C may be appropriately determined from the viewpoint of obtaining a target peeling strength (or adhesiveness) based on the thickness of the stacked body to be pressurized. For example, a range of 0.01 mm or more and 0.40 mm or less may be set, a range of 0.05 mm or more and 0.30 mm or less is preferable, and a range of 0.10 mm or more and 0.25 mm or less is more preferable.

The pressure (also referred to as “crimping pressure” below) applied in the thickness direction of the recording medium (that is, the stacked body) P2 may be set to be, for example, in a range of 48 MPa or more and 120 MPa or less at the maximum pressure. For example, a range of 60 MPa or more and 110 MPa or less is preferable, and a range of 80 MPa or more and 100 MPa or less is more preferable. In a case where the crimping pressure is 48 MPa or more, it is easy to obtain sufficient adhesiveness. Further, in a case where the crimping pressure is 120 MPa or less, it is easy to suppress tearing, deformation, and the like of the recording medium during pressurization.

The crimping pressure is measured by a commercially available pressure measuring film. Specific examples of the pressure measuring film include a pressure measuring film PRESCALE manufactured by Fujifilm Co., Ltd. The maximum pressure represents the maximum value in a change in pressure during a period in which a stacked body pressurizing unit applies pressure to the stacked body.

As the pressurizing device 230, a commercially available device may be used. Specific examples of the commercially available device include PRESSLE LEADA, PRESSLE CORE, and PRESSLE Bee manufactured by Toppan Forms Co., Ltd., PS-500H, PS-500, EX-4100WI, EX-4100W, EX-4100/4150, and PS-100 manufactured by Duplo Seiko Co., Ltd., and the like.

The recording medium (that is, the stacked body) P2 may be pressurized without being heated or may be pressurized while being heated. That is, the pressurizing device 230 may not include the heating unit, and thus pressurize the stacked body without heating the stacked body, or may include the heating unit and thus pressurize the stacked body while heating the stacked body.

In a case where pressure is applied to the recording medium P2 passing through the pressurizing device 230, the crimping toner on the recording medium P2 is fluidized by the pressure and adhesiveness is exhibited. The overlapping surfaces of the recording medium P2 or the overlapping surfaces of the recording medium P2 and another medium are adhered to each other by the fluidized crimping toner to produce a crimped printed matter P3. Facing surfaces of the crimped printed matter P3 partially or totally adhere to each other.

The pressurizing device 230 may or may not have an internal heating source (for example, a halogen heater) for heating the recording medium P2. Even though the pressurizing device 230 does not have an internal heating source, the internal temperature of the pressurizing device 230 may be increased to a temperature equal to or higher than the environmental temperature by heat generated by a motor or the like included in the pressurizing device 230.

The completed crimped printed matter P3 is transported out of the pressurizing device 230.

A first form of the crimped printed matter P3 is a crimped printed matter including a folded recording medium in which the facing surfaces of the medium have adhered to each other by the crimping toner. A second form of the crimped printed matter P3 is a crimped printed matter including a plurality of stacked recording media in which the facing surfaces of the media have adhered to each other by the crimping toner. The crimped printed matter P3 is manufactured by the image forming system including the stacking device 220.

The crimping apparatus 200 in the image forming system 50 is not limited to a system in which the recording medium P2 is continuously transported from the stacking device 220 to the pressurizing device 230. The crimping apparatus 200 may be an apparatus in which the recording medium P2 passing through the stacking device 220 is stored, and, after the storage amount of the recording medium P2 reaches a predetermined amount, the recording medium P2 is transported to the pressurizing device 230.

The stacking device 220 and the pressurizing device 230 may be close to each other or may be separated from each other. In a case where the stacking device 220 and the pressurizing device 230 are separated from each other, the stacking device 220 and the pressurizing device 230 may be joined to each other by, for example, a transport unit (for example, a belt conveyor) that transports the recording medium P2.

In the image forming system and the image forming method according to the present exemplary embodiment, in the unit 10T using the crimping toner, the crimping toner having a volume average particle diameter larger than the volume average particle diameter of the color toners used in the units 10Y, 10M, 10C, and 10K is used. As a result, the adhesive strength of the crimping toner is improved as compared with a case where the volume average particle diameter of the crimping toner is equal to or less than the volume average particle diameter of the color toner. By making the volume average particle diameter of the crimping toner more than the volume average particle diameter of the color toner, it is possible to obtain favorable image quality with the color toner, and high adhesive strength with the crimping toner is realized.

The crimping toner used in the image forming system and the image forming method according to the present exemplary embodiment has pressure responsiveness that performs phase transition depending on the pressure. Since the crimping toner that is pressure-responsive particles performs phase transition by the pressure, the function of adhering facing surfaces of a recording medium to each other is exerted in the production of a printed matter.

The present inventors have examined the image forming system and an image forming method capable of manufacturing a printed matter that has a wide selection range of types of available recording media (for example, a difference in basis weight or the like) and has high peeling strength, by using the crimping toner having pressure-responsiveness.

The crimping toner contains a pressure plastic material. The hardness of the crimping toner is ensured by finely dispersing the pressure plastic material in the crimping toner. By thermal fixing of the crimping toner in the heating step, the crimping toner is melted by heat, and the pressure plastic material is ultra-finely dispersed. In the pressurizing step, the pressure plastic material is softened by the pressure, the crimping toners adhere to each other, thereby adhering the facing surfaces of the crimped printed matter P3 to each other. The pressure plastic material becomes hard again and exhibits appropriate adhesive strength in a case where the facing surfaces of the crimped printed matter P3 are peeled off from each other.

In order to improve the adhesive strength of the crimping toner, for example, it is desirable to disperse the pressure plastic material in the crimping toner as uniformly as possible in a toner layer in a case where the pressure plastic material is thermally fixed. The present inventors have found that, in a case where the adhesive strength is evaluated by causing the particle diameter of the crimping toner to differ, the deformation amount of the crimping toner layer in which the particle diameter of the crimping toner is set to be large is larger, and the dispersion of the pressure plastic material in the crimping toner layer is improved. Further, the present inventors have found that, in particular, in a case where the crimping toner layer is formed as an upper layer of the color toner layer, by reducing the particle diameter of the color toner, the deformation amount of the crimping toner layer is increased and the adhesive strength is improved. Thus, the present inventors have found that, by using the crimping toner having a volume average particle diameter that is more than the volume average particle diameter of the color toner, the adhesive strength of the crimping toner is improved as compared with a case where the volume average particle diameter of the crimping toner is equal to or less than the volume average particle diameter of the color toner.

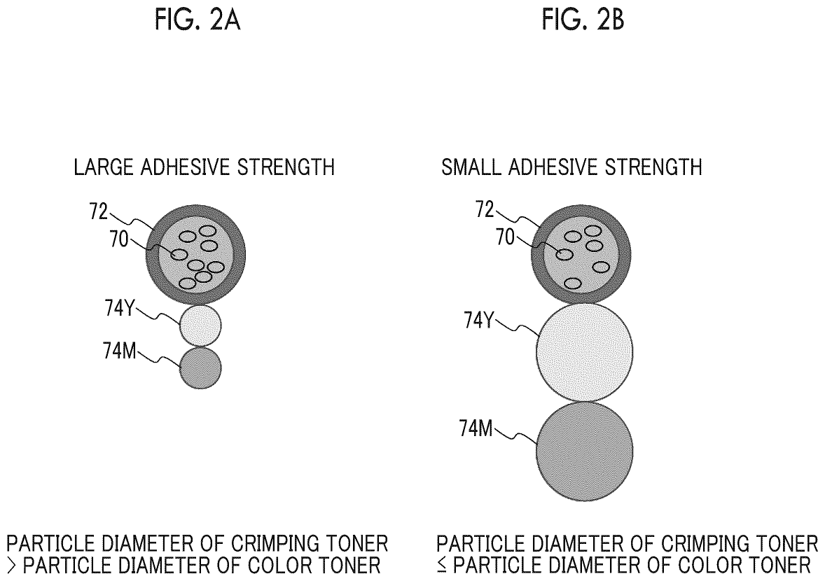

For example, in a case where a crimping toner 72 containing the pressure plastic material 70 is formed as an upper layer of a magenta toner 74M and a yellow toner 74Y as the color toners as shown in FIGS. 2A and 2B, presumably, by making the particle diameter of the crimping toner 72 more than the particle diameters of the magenta toner 74M and the yellow toner 74Y as shown in FIG. 2A, the deformation amount of the layer of the crimping toner 72 is increased, and the adhesive strength is improved, as compared with a case where the particle diameter of the crimping toner 72 is equal to or less than the particle diameters of the magenta toner 74M and the yellow toner 74Y as shown in FIG. 2B.

Further, the adhesive strength can be increased by making the volume average particle diameter of the crimping toner more than the volume average particle diameter of the color toner. However, in a case where the volume average particle diameter of the crimping toner is made too large, there is a problem that it is difficult to share, with the developing device and the like, a special color toner such as a clear toner (for example, volume average particle diameter of 5.8 μm), a white toner (for example, volume average particle diameter of 8.5 μm), a golden toner (for example, volume average particle diameter of 12 μm), a silver toner (for example, volume average particle diameter of 12.2 μm), and a fluorescent toner (such as a fluorescent pink toner (for example, volume average particle diameter of 5.8 μm)). In a case where the volume average particle diameter of the crimping toner is made more than the volume average particle diameters of other special color toners (for example, larger than 13 μm), problems as follows occur: the crimping toner adheres to a developing roll of the developing device; or a read value of an optical sensor that measures the concentration of the crimping toner in a developer containing the crimping toner and a carrier (that is, the ratio of the crimping toner to the content of the developer) varies largely. By reducing the volume average particle diameter of the color toner, it is possible to improve the image quality such as granularity and line reproduction and to enhance the adhesive strength of the crimping toner. However, in a case where the volume average particle diameter of the color toner is made too small, there is a problem that cleaning of the photoconductor becomes difficult and reliability is lowered. Thus, it is desirable that the volume average particle diameter of the crimping toner is, for example, more than the volume average particle diameter of the color toner and less than the maximum volume average particle diameter of the special color toner to be used.

From these points, the volume average particle diameter of the crimping toner is, for example, preferably more than 6 μm, more preferably in a range of more than 6 μm and 13 μm or less, and further preferably in a range of 9 μm or more and 10 μm or less. By using the crimping toner as a large-diameter toner having a volume average particle diameter of more than 6 μm, it is possible to increase the deformation amount of the crimping toner in the heating step, and the adhesive strength of the crimping toner is improved. Further, it is possible to share other special color toners such as clear toners and gold and silver toners with the developing device and the like, and to suppress the cost.

In addition, the volume average particle diameter of the color toner is, for example, preferably 6 μm or less, more preferably in a range of 4 μm or more and 6 μm or less, and further preferably in a range of 4.7 μm or more and 5.8 μm or less. By setting the volume average particle diameter of the color toner to be 6 μm or less, it is possible to obtain favorable image quality with the color toner, and high adhesive strength with the crimping toner is realized.

The volume average particle diameter of the special color toner is, for example, preferably in a range of 4 μm or more and 20 μm or less, and preferably in a range of 5.8 μm or more and 13 μm or less. By setting the volume average particle diameter of the special color toner to be in a range of 5.8 μm or more and 13 μm or less, it is possible to share the crimping toner with the developing device and the like.

The volume average particle diameter of the clear toner is, for example, in a range of 4 μm or more and 20 μm or less, and preferably in a range of 4.7 μm or more and 5.8 μm or less.

The volume average particle diameter of the white toner is, for example, in a range of 4 μm or more and 20 μm or less, and preferably in a range of 6 μm or more and 13 μm or less.

The volume average particle diameter of the golden toner and the silver toner is, for example, in a range of 4 μm or more and 20 μm or less, and preferably in a range of 6 μm or more and 13 μm or less.

The volume average particle diameter of the fluorescent color toner such as the fluorescent pink toner is, for example, in a range of 4 μm or more and 20 μm or less, and preferably in a range of 4.7 μm or more and 5.8 μm or less.

The volume average particle diameter (D50v) is measured using a COULTER MULTISIZER II (manufactured by Beckman Coulter Inc.) and an aperture having an aperture diameter of 100 μm. In 2 mL of a 5% by mass aqueous solution of sodium alkylbenzene sulfonate, the toner in an amount of 0.5 mg or more and 50 mg or less is dispersed. Then, the solution is mixed with an electrolytic solution (ISOTON-II, manufactured by Beckman Coulter Inc.) in an amount of 100 mL or more and 150 mL or less. The mixture is subjected to a dispersion treatment for 1 minute by using an ultrasonic disperser, and the obtained dispersion is used as a sample. For 50,000 particles in the sample having a particle diameter of 2 μm or more and 60 μm or less, particle diameter is measured. A particle diameter at which the cumulative volume of particles smaller than this particle diameter is 50% in a volume-based particle diameter distribution is adopted as a volume average particle diameter (D50v).

For example, it is preferable that the toner mass (TMA) of the crimping toner per unit area is lower than the toner mass of the color toner per unit area. TMA of the color toner is higher than TMA of the crimping toner, for example, desired to increase the deformation amount of the crimping toner layer, because a structure of one or more layers is formed on the recording medium in consideration of color reproducibility, color unevenness, and the like. TMA of the color toner is, for example, in the range of 3.3 g/m² or more and 4.5 g/m² or less. TMA of the crimping toner is preferably set to be, for example, in a range of 1.0 g/m² or more and 2.6 g/m² or less.

TMA of the color toner and TMA of the crimping toner are, for example, preferably controlled by a potential contrast in an electrostatic latent image on the photoconductor (an example of the image holding member). The potential contrast in the electrostatic latent image can be adjusted by controlling a charging potential on the photoconductor and a development bias potential of a developing device. By controlling the potential contrast in the electrostatic latent image, predetermined TMA of the crimping toner is obtained, and high adhesive strength is realized.

The image forming system according to the present exemplary embodiment may include other units in addition to the image forming unit, the applying unit, the heating unit, and the pressurizing unit described above. In addition, the image forming method according to the present exemplary embodiment may include other steps in addition to the image forming step, the applying step, the heating step, and the pressurizing step described above.

For example, the image forming system 50 may include a cutting unit that cuts the recording medium to a predetermined size. The cutting unit includes, for example, as follows: a cutting unit that is disposed between the image forming apparatus 300 and the crimping apparatus 200, and cuts off a region that is a portion of the recording medium P, and in which, for example, the crimping toner is not disposed; a cutting unit that is disposed between the stacking device 220 and the pressurizing device 230 and cuts off a region that is a portion of the recording medium P2, and in which, for example, the crimping toner is not disposed; a cutting unit that is disposed on a downstream side of the crimping apparatus 200 and cuts off a region that is a portion of the crimped printed matter P3, and in which, for example, adhesion with the crimping toner is not performed; and the like. A portion of a region in which the crimping toner is disposed, or a portion of a region in which adhesion with the crimping toner is performed may be cut off by the cutting unit.

The image forming system according to the present exemplary embodiment is not limited to a sheet-fed apparatus. The image forming system according to the present exemplary embodiment may be an apparatus of a type that forms a long crimped printed matter by performing the applying step, the heating step, and the pressurizing step on a long recording medium, and then cuts the long crimped printed matter to a predetermined size.

Examples of the recording medium include paper, coated paper in which the surface of paper is coated with a resin or the like, cloth, a non-woven fabric, a resin film, a resin sheet, and the like.

The crimping toner may be applied to the recording medium in a state where the shape of particles remains, or the crimping toner may be aggregated to form a layer. From the viewpoint of obtaining the sufficient peeling strength (or adhesiveness), for example, a form of a layer is preferable. The layer made of the crimping toner may be a continuous layer or a discontinuous layer.

The layer thickness of the crimping toner on the recording medium is, for example, in a range of 0.2 μm or more and 25 μm or less, and preferably in a range of 0.4 μm or more and 15 μm or less.

The application position of the crimping toner may be the entire surface of a recording medium or a portion of the recording medium. The application position of the crimping toner to the recording medium may be on an image formed on the recording medium, on a non-image portion, or both. Specific example includes a form in which the crimping toner is applied onto at least a portion of a non-image portion in a net-dot pattern, a form in which the crimping toner is applied onto at least a portion of an image portion in a net-dot pattern, a form in which the crimping toner is disposed onto at least a portion of both the non-image portion and the image portion in a net-dot pattern, and the like.

As in the case of the image forming system 50 shown in FIG. 1, a composite image may be formed on the surface of the image holding member or the intermediate transfer member by using both an image forming color toner and the crimping toner, and the composite image may be transferred to the surface of the recording medium.

The crimping toner is, for example, preferably transparent. In a case where the crimping toner is applied onto the image portion of the recording medium, the visibility of the image portion is improved due to the transparency of the crimping toner. In the present exemplary embodiment, “transparency” means that the average transmittance of light in a visible region (400 nm or more and 700 nm or less) of a region to which the crimping toner has been applied is 10% or more, and is, for example, preferably 50% or more, more preferably 80% or more, and further preferably 90% or more. The average transmittance is measured by using a spectrophotometer V700 (manufactured by Nippon Spectroscopy Co., Ltd.).

### Crimping Toner

The crimping toner used in the image forming system and the image forming method according to the present exemplary embodiment is a toner that performs phase transition depending on the pressure, as described above. Since the crimping toner performs phase transition by the pressure, the function of adhering facing surfaces of a recording medium to each other is exerted in the production of a printed matter.

The crimping toner according to the present exemplary embodiment contains at least base particles, and may contain an external additive, as necessary.

The base particles contained in the crimping toner include, as the pressure plastic material, a binder resin such as a styrene-based resin containing styrene and other vinyl monomers as a polymerization component, a (meth)acrylic acid ester-based resin containing (meth)acrylic acid ester as a polymerization component, or the like.

Examples of other vinyl monomers include styrene-based monomers. Examples of the styrene-based monomer other than styrene include vinylnaphthalene; alkyl-substituted styrene such as α-methylstyrene, o-methylstyrene, m-methylstyrene, p-methylstyrene, p-ethylstyrene, 2,4-dimethylstyrene, p-n-butyl styrene, p-tert-butyl styrene, p-n-hexyl styrene, p-n-octyl styrene, p-n-nonyl styrene, p-n-decyl styrene, and p-n-dodecyl styrene; aryl-substituted styrene such as p-phenylstyrene; alkoxy-substituted styrene such as p-methoxystyrene; halogen-substituted styrene such as p-chlorostyrene, 3,4-dichlorostyrene, p-fluorostyrene, and 2,5-difluorostyrene; nitro-substituted styrene such as m-nitrostyrene, o-nitrostyrene, and p-nitrostyrene; and the like. One type of the styrene-based monomer may be used alone, or two or more types of the styrene-based monomers may be used in combination.

Examples of other vinyl monomers include acrylic monomers. Examples of the acrylic monomers preferably include at least one acrylic monomer selected from the group consisting of (meth)acrylic acid and (meth)acrylic acid esters.

As the (meth)acrylic acid ester as the other vinyl monomer and the (meth)acrylic acid ester contained in the (meth)acrylic acid ester-based resin, (meth)acrylic acid alkyl ester, (meth)acrylic acid carboxy-substituted alkyl ester, (meth)acrylic acid hydroxy-substituted alkyl ester, (meth)acrylic acid alkoxy-substituted alkyl ester, di(meth)acrylic acid ester, and the like are exemplified. One type of the acrylic monomer may be used alone, or two or more types of the acrylic monomers may be used in combination.

Examples of the (meth)acrylic acid alkyl ester include methyl (meth)acrylate, ethyl (meth)acrylate, propyl (meth)acrylate, isopropyl (meth)acrylate, n-butyl (meth)acrylate, isobutyl (meth)acrylate, n-hexyl (meth)acrylate, 2-ethylhexyl (meth)acrylate, lauryl (meth)acrylate, stearyl (meth)acrylate, cyclohexyl (meth)acrylate, dicyclopentanyl (meth)acrylate, isobornyl (meth)acrylate, and the like.

Examples of the (meth)acrylic acid carboxy-substituted alkyl ester include 2-carboxyethyl (meth)acrylate and the like.

Examples of the (meth)acrylic acid hydroxy-substituted alkyl ester include 2-hydroxyethyl (meth)acrylate, 2-hydroxypropyl (meth)acrylate, 3-hydroxypropyl (meth)acrylate, and 2-hydroxybutyl (meth)acrylate, 3-hydroxybutyl (meth)acrylate, 4-hydroxybutyl (meth)acrylate, and the like.

Examples of the (meth)acrylic acid alkoxy-substituted alkyl ester include 2-methoxyethyl (meth)acrylate and the like.

Examples of the di(meth)acrylic acid ester include ethylene glycol di(meth)acrylate, diethylene glycol di(meth)acrylate, triethylene glycol di(meth)acrylate, butanediol di(meth)acrylate, pentandiol di(meth)acrylate, hexanediol di(meth)acrylate, nonanediol di(meth)acrylate, decanediol di(meth)acrylate, and the like.

Examples of the (meth)acrylic acid ester include 2-(diethylamino)ethyl (meth)acrylate, benzyl (meth)acrylate, methoxypolyethylene glycol (meth)acrylate, and the like.

In addition to the styrene-based monomer and the acrylic monomer, examples of other vinyl monomers contained in the styrene-based resin as the polymerization component also include (meth)acrylonitrile; vinyl ethers such as vinyl methyl ether and vinyl isobutyl ether; vinyl ketones such as vinyl methyl ketone, vinyl ethyl ketone, and vinyl isopropenyl ketone; and olefins such as isoprene, butene, and butadiene.

The base particle is, for example, preferably transparent, but may contain a colorant (for example, a pigment or a dye) in a range in which the visibility of the image is not impaired. In addition, the base particles may contain other components, as necessary. Examples of the other components include a release agent (for example, hydrocarbon-based wax such as paraffin wax; natural wax such as carnauba wax, rice wax, and candelilla wax; synthetic or mineral/petroleum-based wax such as montan wax; ester-based wax such as fatty acid esters and montanic acid esters; and the like), a charge control agent, and the like.

The base particles may be base particles having a single-layer structure, or may be base particles having a core-shell structure with a core portion and a shell layer coating the core portion. From the viewpoint of suppressing fluidization of the crimping toner in a state of not being pressurized, it is preferable that the base particles have, for example, a core-shell structure.

Examples of the resin contained in the shell layer include polystyrene; a non-vinyl-based resin such as an epoxy resin, a polyester resin, a polyurethane resin, a polyamide resin, a cellulose resin, a polyether resin, or a modified rosin; and the like. One type of the resin may be used alone, or two or more types of the resins may be used in combination.

From the viewpoint of ease of handling the base particle, the volume average particle diameter (D50v) of the base particle is, for example, 4 μm or more, and preferably 6 μm or more. An upper limit is, for example, 15 μm or less, preferably 13 μm or less, and more preferably 10 μm or less.

Examples of the external additive include inorganic particles. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO·SiO₂·K₂O·(TiO₂)ₙ, Al₂O₃·2SiO₂, CaCO₃, MgCO₃, BaSO₄, MgSO₄, and the like.

The surface of the inorganic particles serving as the external additive may be subjected to, for example, a hydrophobic treatment. The hydrophobic treatment is performed, for example, by dipping the inorganic particles in a hydrophobic treatment agent, or the like. The hydrophobic treatment agent is not particularly limited, and examples thereof include a silane-based coupling agent, silicone oil, a titanate-based coupling agent, an aluminum-based coupling agent, and the like. Such hydrophobic treatment agent may be used alone or in combination of two or more kinds thereof. The amount of the hydrophobizing agent is, for example, 1 part by mass or more and 10 parts by mass or less with respect to 100 parts by mass of the inorganic particles.

Examples of external additives also include resin particles (resin particles such as polystyrene, polymethylmethacrylate, and melamine resins), a cleaning activator (for example, a metal salt of a higher fatty acid represented by zinc stearate or fluorine-based polymer particles), and the like.

The external added amount of external additives with respect to the base particles is, for example, in a range of 0.01% by mass or more and 5% by mass or less, and preferably in a range of 0.01% by mass or more and 2.0% by mass or less.

As the crimping toner, for example, a toner containing a styrene-based resin which contains styrene and other vinyl monomers as polymerization components and a (meth)acrylic acid ester-based resin which contains at least two kinds of (meth)acrylic acid esters as polymerization components and in which a mass ratio of the (meth)acrylic acid esters to all polymerization components is 90% by mass or higher, the pressure-responsive particles have at least two glass transition points, and a difference between the lowest glass transition temperature and the highest glass transition temperature is 30° C. or higher, which is disclosed in JP2021-018422A, is preferable.

The reason why the crimping toner is likely to perform phase transition by the pressure and is excellent in adhesiveness is presumed as follows.

Presumably, because a styrene-based resin and a (meth)acrylic acid ester-based resin are poorly compatible with each other in general, both the resins may be contained in the crimping toner in a phase-separated state. Furthermore, presumably, in a case where the crimping toner is pressurized, the (meth)acrylic acid ester-based resin having a relatively low glass transition temperature may perform fluidization first, the fluidization may affect the styrene-based resin, and thus both of the resins may be fluidized. After being fluidized by pressurization, both the resins in the crimping toner are solidified as the pressure decreases and form a resin layer. Presumably, at this time, due to the poor compatibility, the resins may form the phase separation state again.

In the (meth)acrylic acid ester-based resin containing at least two kinds of (meth)acrylic acid esters as polymerization components, at least two kinds of ester groups are bonded to the main chain of the (meth)acrylic acid ester-based resin. Presumably, therefore, compared to a homopolymer of a (meth)acrylic acid ester, the (meth)acrylic acid ester-based resin may have a lower degree of molecular alignment in a solid state, and thus more readily fluidized by the application of pressure. In addition, in a case where the ratio of the mass of the (meth)acrylic acid esters to the total mass of polymerization components is 90% by mass or more, at least two kinds of ester groups are present at high density. Presumably, therefore, the degree of molecular alignment of the (meth)acrylic acid ester-based resin in a solid state may be further reduced, and thus the resin may be easily fluidized by the pressurization. Therefore, presumably, the crimping toner may be more readily fluidized by pressure, that is, more readily perform phase transition by pressure, compared to a toner containing a homopolymer of (meth)acrylic acid ester as a (meth)acrylic acid ester-based resin.

In addition, the (meth)acrylic acid ester-based resin, which contain at least two kinds of (meth)acrylic acid esters as polymerization components and in which the ratio of the mass of the (meth)acrylic acid esters to the total mass of polymerization components is 90% by mass or more, has a low degree of molecular alignment even in a case where the resin is solidified again. Presumably, therefore, the phase separation of the (meth)acrylic acid ester-based resin and the styrene-based resin may be microscale phase separation. Presumably, the smaller the scale of phase separation of the styrene-based resin and the (meth)acrylic acid ester-based resin is, the higher the uniformity of an adhesive surface may be for an adherend, and the higher the adhesiveness may be. Therefore, it is presumed that the crimping toner is excellent in adhesiveness as compared with a crimping toner containing a homopolymer of the (meth)acrylic acid ester as the (meth)acrylic acid ester-based resin.

It is preferable that, for example, the crimping toner has at least two glass transition temperatures, and the difference between the lowest glass transition temperature and the highest glass transition temperature is 30° C. or higher. From the viewpoint of causing the crimping toner to readily perform phase transition by pressure, the difference between the lowest glass transition temperature and the highest glass transition temperature is, for example, more preferably 40° C. or higher, further preferably 50° C. or higher, and particularly preferably 60° C. or higher. An upper limit of the difference between the lowest glass transition temperature and the highest glass transition temperature is, for example, 140° C. or lower, 130° C. or lower, or 120° C. or lower.

The glass transition temperature of the crimping toner is obtained from a differential scanning calorie curve (DSC curve) obtained by compressing resin particles to prepare a plate-shaped sample and performing differential scanning calorimetry (DSC). More specifically, the glass transition temperature is determined according to “extrapolated glass transition onsetting temperature” described in the method for determining glass transition temperature in JIS K7121: 1987 “testing methods for transition temperature of plastics”.

The crimping toner performs phase transition by pressure and satisfies the following expression 1.

$$10 ° C . \leq T 1 - T 2 \qquad Expression 1$$

In Expression 1, T1 is a temperature at which the crimping toner exhibits a viscosity of 10,000 Pa's under pressure of 1 MPa, and T2 is a temperature at which the crimping toner exhibits a viscosity of 10,000 Pa's at pressure of 10 MPa. A method of obtaining T1 and T2 will be described later.

From the viewpoint of causing the crimping toner to easily perform phase transition by pressure, the temperature difference (T1-T2) is, for example, 10° C. or higher, preferably 15° C. or higher, and more preferably 20° C. or higher. From the viewpoint of suppressing the fluidization of the crimping toner in a state of not being pressurized, the temperature difference (T1-T2) is, for example, preferably 120° C. or lower, more preferably 100° C. or lower, and further preferably 80° C. or lower.

The value of T1 is, for example, 140° C. or lower, preferably 130° C. or lower, more preferably 120° C. or lower, and further preferably 115° C. or lower. A lower limit of the temperature T1 is, for example, 80° C. or higher, and preferably 85° C. or higher. The value of T2 is, for example, 40° C. or higher, preferably 50° C. or higher, and more preferably 60° C. or higher. An upper limit of the temperature T2 is, for example, 85° C. or lower.

For example, a temperature difference (T1-T3) between the temperature T1 at which the crimping toner has a viscosity of 10,000 Pa's under the pressure of 1 MPa and a temperature T3 at which the crimping toner has a viscosity of 10,000 Pa's under pressure of 4 MPa is an index showing how readily the pressure-responsive particles perform phase transition by pressure. The temperature difference (T1-T3) is, for example, preferably 5° C. or higher. The temperature difference (T1-T3) is generally 25° C. or lower. From the viewpoint of causing the crimping toner to easily perform phase transition by pressure, the temperature difference (T1-T2) is, for example, preferably 5° C. or higher, and more preferably 10° C. or higher. An upper limit of the temperature difference (T1-T2) is generally 25° C. or lower.

From the viewpoint of obtaining the temperature difference (T1-T3) of 5° C. or higher, the temperature T3 at which the crimping toner has a viscosity of 10000 Pa's under the pressure of 4 MPa is, for example, preferably 90° C. or lower, more preferably 85° C. or lower, and further preferably 80° C. or lower. A lower limit of the temperature T3 is, for example, preferably 60° C. or higher.

The temperature T1, the temperature T2, and the temperature T3 are determined by the following method. The crimping toner is compressed, thereby preparing a pellet-like sample. The pellet-like sample is set in a flow tester (CFT-500 manufactured by Shimadzu Corporation), a pressure set to 1 MPa is applied to the sample, and the viscosity of the sample at each temperature under 1 MPa is measured. From the obtained viscosity graph, the temperature T1 at which the viscosity is 104 Pa's under the applied pressure of 1 MPa is determined. The temperature T2 is determined by the same method as the method used for determining the temperature T1, except that the applied pressure is changed to 10 MPa from 1 MPa. The temperature T3 is determined by the same method as the method used for determining the temperature T1, except that the applied pressure is changed to 4 MPa from 1 MPa. From the temperature T1 and the temperature T2, the temperature difference (T1-T2) is calculated. From the temperature T1 and the temperature T3, the temperature difference (T1-T3) is calculated.

The crimping toner is obtained, for example, by externally adding an external additive to the base particles after the base particles are manufactured.

The base particles may be manufactured by any of a dry manufacturing method (for example, a kneading and pulverizing method or the like) or a wet manufacturing method (for example, an aggregation and coalescence method, a suspension polymerization method, a dissolution suspension method, or the like). There are no particular restrictions on these manufacturing methods, and known manufacturing methods are adopted. Among the above methods, for example, the aggregation and coalescence method may be used for obtaining the base particles. A method of manufacturing base particles by an aggregation and coalescence method as disclosed in JP2021-018422A is exemplified as an example.

For example, by adding an external additive to the obtained dry base particles and mixing the external additive and the base particles together, the crimping toner is manufactured. The mixing may be performed, for example, using a V blender, a Henschel mixer, a Lödige mixer, or the like. Furthermore, coarse particles of the crimping toner may be removed as necessary by using a vibratory sieving machine, a pneumatic sieving machine, or the like.

Electrostatic Charge Image Developer Containing Crimping Toner

The electrostatic charge image developer containing the crimping toner may be a one-component developer which contains only the crimping toner or a two-component developer which is obtained by mixing together the crimping toner and a carrier.

The carrier is not particularly limited, and examples thereof include known carriers. Examples of the carrier include a coated carrier obtained by coating the surface of a core material consisting of magnetic powder with a resin; a magnetic powder dispersion-type carrier obtained by dispersing and mixing magnetic powder in a matrix resin; and a resin impregnation-type carrier obtained by impregnating porous magnetic powder with a resin; and the like. Each of the magnetic powder dispersion-type carrier and the resin impregnation-type carrier may be a carrier obtained by coating the surface of a core material, which is particles configuring the carrier, with a resin.

Examples of the magnetic powder include magnetic metals such as iron, nickel, and cobalt and magnetic oxides such as ferrite and magnetite.

Examples of the coating resin and matrix resin include polyethylene, polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, a styrene-acrylic acid ester copolymer, a straight silicone resin configured with an organosiloxane bond or a product obtained by modifying the straight silicone resin, a fluororesin, polyester, polycarbonate, a phenol resin, an epoxy resin, and the like. The coating resin and the matrix resin may contain other additives such as conductive particles. Examples of the conductive particles include metals such as gold, silver, and copper, and particles such as carbon black, titanium oxide, zinc oxide, tin oxide, barium sulfate, aluminum borate, and potassium titanate.

The surface of the core material is coated with a resin, for example, by a coating method using a solution for forming a coating layer obtained by dissolving the coating resin and various additives (used as necessary) in an appropriate solvent, and the like. The solvent is not particularly limited, and may be selected in consideration of the type of the resin used, coating suitability, and the like.

Specific examples of the resin coating method include a dipping method of dipping the core material in the solution for forming a coating layer; a spray method of spraying the solution for forming a coating layer to the surface of the core material; a fluidized bed method of spraying the solution for forming a coating layer to the core material that is floating by an air flow; a kneader coater method of mixing the core material of the carrier with the solution for forming a coating layer in a kneader coater and then removing solvents; and the like.

The mixing ratio (mass ratio) of the crimping toner and the carrier in the two-component developer is, for example, in a range of the crimping toner: the carrier=1:100 or more and 30:100 or less, and preferably in a range of 3:100 or more and 20:100 or less.

Color Toner, Special Color Toner, Electrostatic Charge Image Developer Containing Color Toner, and Electrostatic Charge Image Developer Containing Special Color Toner

The color toner is, for example, a color toner such as a yellow toner, a magenta toner, a cyan toner, a black toner, or the like. The special color toner is a clear toner, a white toner, a golden toner, a silver toner, a fluorescent color toner such as a fluorescent pink toner, or the like. As the color toner, the special color toner, the electrostatic charge image developer containing the color toner, and the electrostatic charge image developer containing the special color toner, known toners in the related art may be used, and these toners may be prepared by a known method in the related art. The image formation with the special color toner may be performed by an image forming apparatus and an image forming method similar to those with the color toner.

### Examples

The present invention will be described below in more detail with reference to examples and comparative examples, but the present invention is not limited to the examples as follows.

Preparation of Developer Containing Crimping Toner Preparation of Styrene-Based Resin Particle Dispersion (St1)
Styrene: 390 parts by mass
n-Butyl acrylate: 100 parts by mass
Acrylic acid: 10 parts by mass
Dodecanethiol: 7.5 parts by mass

The above materials are mixed and dissolved to prepare a monomer solution (the mass ratio of the polymerization component is styrene: n-butyl acrylate: acrylate=78:20:2). 8 parts by mass of an anionic surfactant (Dowfax2A1 manufactured by The Dow Chemical Company) are dissolved in 205 parts by mass of deionized water, and the above monomer solution is added thereto so that the monomers are dispersed and emulsified, thereby obtaining an emulsion. 2.2 parts by mass of an anionic surfactant (Dowfax2A1 manufactured by The Dow Chemical Company) are dissolved in 462 parts by mass of deionized water. The obtained solution is put in a polymerization flask equipped with an agitator, a thermometer, a reflux condenser, and a nitrogen gas introduction tube, heated to 73° C. with agitation, and kept as it is. 3 parts by mass of ammonium persulfate are dissolved in 21 parts by mass of deionized water, the obtained solution is added dropwise to the polymerization flask for 15 minutes via a metering pump, and then the emulsion is added dropwise for 160 minutes via a metering pump. Then, the polymerization flask is kept at 75° C. for 3 hours with slow agitation, and then returned to room temperature (25° C.). As a result, a styrene-based resin particle dispersion (St1) containing styrene-based resin particles is obtained. The resin particles in St1 have a volume average particle diameter (D50v) of 174 nm and a weight average molecular weight of 49 k measured by GPC (UV detection), the glass transition temperature of St1 is 54° C., and the solid content of St1 is 42%.

The styrene-based resin particle dispersion (St1) is dried so that the styrene-based resin particles are collected. By using a differential scanning calorimeter (DSC-60A, manufactured by Shimadzu Corporation), the thermal behavior of the styrene-based resin particles at a temperature in a range of −150° C. to 100° C. is analyzed. As a result, one glass transition temperature is observed at 54° C.

Preparation of Composite Resin Particle Dispersion (M1)
Styrene-based resin particle dispersion (St1): 1,190 parts by mass (solid content: 500 parts by mass)
2-Ethylhexyl acrylate: 250 parts by mass
n-Butyl acrylate: 250 parts by mass
Deionized water: 982 parts by mass

The above materials are placed in a polymerization flask (the mass ratio of the resin is styrene-based resin: acrylic-based resin=50:50), and agitated at 25° C. for one hour, and then heated to 70° C. 2.5 parts by mass of ammonium persulfate are dissolved in 75 parts by mass of deionized water, and the obtained solution is added dropwise to the polymerization flask for 60 minutes via a metering pump. Then, the polymerization flask is kept at 70° C. for 3 hours with slow agitation, and then returned to room temperature. As a result, a composite resin particle dispersion (M1) containing composite resin particles is obtained. The resin particles have a volume average particle diameter (D50v) of 219 nm and a weight average molecular weight of 219 k measured by GPC (UV detection), and the solid content of M1 is 32% by mass.

The composite resin particle dispersion (M1) is dried so that the composite resin particles are collected. By using a differential scanning calorimeter (DSC-60A, manufactured by Shimadzu Corporation), the thermal behavior of the composite resin particles at a temperature in a range of −150° C. to 100° C. is analyzed. As a result, two glass transition temperatures are observed at −52° C. and 54° C. (Tg difference=106° C.).

### Preparation of Crimping Toner (1)

Composite resin particle dispersion (M1): 504 parts by mass
Deionized water: 710 parts by mass
Anionic surfactant (Dowfax2A1 manufactured by The Dow Chemical Company): 1 part by mass

The above materials are put in a reaction vessel equipped with a thermometer and a pH meter, and a 1.0% by mass of an aqueous nitric acid solution is added thereto under a temperature of 25° C. so that the pH is adjusted to 3.0. Then, in a state where the obtained solution is being dispersed with a homogenizer (ULTRA-TURRAX T50 manufactured by IKA) at a rotation speed of 5,000 rpm, 23 parts by mass of 2.0% by mass of an aqueous aluminum sulfate solution are added thereto. Then, an agitator and a mantle heater are installed in the reaction vessel. The reaction vessel is heated to 40° C. at a heating rate of 0.2° C./min, and after the temperature exceeds 40° C., the reaction vessel is heated at a heating rate of 0.05° C./min. The particle diameter is measured every 10 minutes with MULTISIZER II (aperture diameter: 50 μm, manufactured by Beckman Coulter, Inc.). The reaction vessel is kept at the temperature at which the volume average particle diameter reached 5.0 μm, and 170 parts by mass of the styrene-based resin particle dispersion (St1) is added thereto for 5 minutes. After the addition of St1 ends, the reaction vessel is kept at 50° C. for 30 minutes. Then, a 1.0% by mass of aqueous sodium hydroxide solution is added thereto so that the pH of the slurry is adjusted to 6.0. Then, in a state where the pH is being adjusted to 6.0 every 5° C., the reaction vessel is heated to 90° C. at a heating rate of 1° C./min and kept at 90° C. As a result of observing the shape and surface properties of the particles with an optical microscope and a field emission scanning electron microscope (FE-SEM), the coalescence of the particles is confirmed after 10 hours. Therefore, the vessel is cooled to 30° C. for 5 minutes with cooling water.

The cooled slurry is passed through a nylon mesh with an opening size of 15 μm so that coarse particles are removed, and the slurry having passed through the mesh is filtered under reduced pressure by using an aspirator. The solids remaining on the filter paper are crushed as finely as possible by hand and added to deionized water (temperature: 30° C.) in an amount 10 times the amount of the solids, and the obtained solution is agitated for 30 minutes. Thereafter, the solution is filtered using an aspirator under reduced pressure, the solids remaining on the filter paper are crushed as finely as possible by hand and added to deionized water (temperature: 30° C.) in an amount 10 times the mass of the solids. The obtained solution is agitated for 30 minutes and then filtered again under reduced pressure by using an aspirator, and the electric conductivity of the filtrate is measured. This operation is repeated until the electric conductivity of the filtrate becomes 10 μS/cm or less, and the solids are washed.

The washed solids are finely crushed with a wet and dry granulation sizing machine (Comil) and vacuum-dried in an oven at 25° C. for 36 hours, thereby obtaining base particles (1). The base particles (1) have a volume average particle diameter of 4.7 μm.

100 parts by mass of the base particles (1) and 1.5 parts by mass of hydrophobic silica (RY50 manufactured by Nippon Aerosil Co., Ltd.) are mixed together by using a sample mill at a rotation speed of 13,000 rpm for 30 seconds. The mixture is sieved with a vibrating sieve having an opening size of 45 μm, thereby obtaining a crimping toner (1).

The crimping toner (1) is sampled, and the thermal behavior of the sample at a temperature in a range of −150° C. to 100° C. is analyzed using a differential scanning calorimeter (DSC-60A, manufactured by Shimadzu Corporation). As a result, two glass transition temperatures are observed at −52° C. and 54° C. (Tg difference=106° C.).

In a case where the temperature T1 and the temperature T2 of the crimping toner (1) are obtained by the measurement method described above, the crimping toner (1) satisfies Expression 1 “10° C.≤T1−T2”.

The cross section of the crimping toner (1) is observed with a scanning electron microscope (SEM). As a result, a sea-island structure is observed. In addition, the crimping toner (1) have a core portion in which island phases are present and a shell layer in which no island phase is present. The sea phase contains a specific styrene-based resin, and the island phases contain a specific (meth)acrylic acid ester-based resin. By the measurement method described above, the average diameter of the island phases is determined. The average diameter of the island phases is 200 nm.

Preparation of Developer (1)
Mn—Mg—Sr-based ferrite particles (average particle diameter: 40 μm): 100 parts by mass
Toluene: 14 parts by mass
Polymethyl methacrylate: 2 parts by mass
Carbon black (VXC72 manufactured by Cabot Corporation): 0.12 parts by mass

The above materials excluding ferrite particles are mixed with glass beads (diameter: 1 mm, in the same amount as toluene), and the mixture is agitated with a sand mill manufactured by Kansai Paint Co., Ltd. at a rotation speed of 1,200 rpm for 30 minutes, thereby obtaining a dispersion. The dispersion and the ferrite particles are put in a vacuum deaeration-type kneader and dried under reduced pressure with agitating, thereby obtaining a resin-coated carrier.

10 parts by mass of the crimping toner (1) and 100 parts by mass of the above resin-coated carrier are put into a V-type blender, agitated for 20 minutes, and then sieved with a vibrating sieve having an opening size of 212 μm, thereby obtaining a developer (1).

### Evaluation of Phase Transition of Crimping Toner

The temperature difference (T1-T3), which is an index indicating how easily particles perform phase transition by pressure, is obtained. The respective particles are sampled, the temperature T1 and the temperature T3 of the samples are measured with a flow tester (CFT-500 manufactured by Shimadzu Corporation), and the temperature difference (T1-T3) is calculated. T3 is 75° C., and the temperature difference (T1-T3) is 15° C.

### Preparation of Crimping Toner (2) and Developer (2)

A crimping toner (2) is prepared in the similar manner to the crimping toner (1) except that the volume average particle diameter of the crimping toner is set to 6.0 μm, and a developer (2) is prepared in the similar manner to the developer (1). The volume average particle diameter of the crimping toner (2) is 6.0 μm.

### Preparation of Crimping Toner (3) and Developer (3)

A crimping toner (3) is prepared in the similar manner to the crimping toner (1) except that the volume average particle diameter of the crimping toner is set to 9.0 μm, and a developer (3) is prepared in the similar manner to the developer (1). The volume average particle diameter of the crimping toner (3) is 9.0 μm.

### Preparation of Crimping Toner (4) and Developer (4)

A crimping toner (4) is prepared in the similar manner to the crimping toner (1) except that the volume average particle diameter of the crimping toner is set to 12.0 μm, and a developer (4) is prepared in the similar manner to the developer (1). The volume average particle diameter of the crimping toner (4) is 12.0 μm.

### Examples

Image formation using the color toner and application of the crimping toner are performed under the following experimental conditions, by using the image forming system shown in FIG. 1. Crimping toners and color toners having different volume average particle diameters shown in Table 1 are used. TMA of each of the crimping toner is adjusted to 1.8 g/m², TMA of the color toner having a volume average particle diameter of 4.7 μm is adjusted to 3.3 g/m², and TMA of the color toner having a volume average particle diameter of 5.8 μm is adjusted to 4.0 g/m². The respective color toners of yellow (Y), magenta (M), cyan (C), and black (K) (manufactured by Fujifilm Business Innovation Co., Ltd., for Revoria Press PC1120, volume average particle diameter of 4.7 μm, and for Color1000i Press, volume average particle diameter of 5.8 μm) are used as the color toners. Under the following apparatus and conditions, 10 parts of a crimped printed matter which is folded in half so that the image-forming surfaces are located on the inside and the image-forming surfaces are adhered to each other are continuously produced, and the peeling strength is evaluated. Table 1 shows the results.

### Experimental Conditions

Image forming apparatus: image forming system including an image forming apparatus of a 5-series tandem type and an intermediate transfer type (manufactured by Fujifilm Business Innovation Co., Ltd., introducing a crimping toner into an image forming unit for special toner overprinting of Revoria Press PC1120), a folding device, and a pressurizing device
Color toner: color toner having a volume average particle diameter shown in Table 1.
Developer: crimping toner having a volume average particle diameter shown in Table 1.
Recording medium: NColor 104 paper, basis weight 104.7 g/m² (manufactured by Fujifilm Business Innovation Co., Ltd.)
Heating device: a heating roll is used, and the setting temperature of the heating roll is set to 160° C.
Stacking device: device that folds a recording medium in half so that image-forming surfaces are located on the inside.
Pressurizing device: roll pairs spaced apart at a distance C of 0.12 mm are used, a processing speed is 80 m/min, and pressure applied to a stacked body is set to 90 MPa.

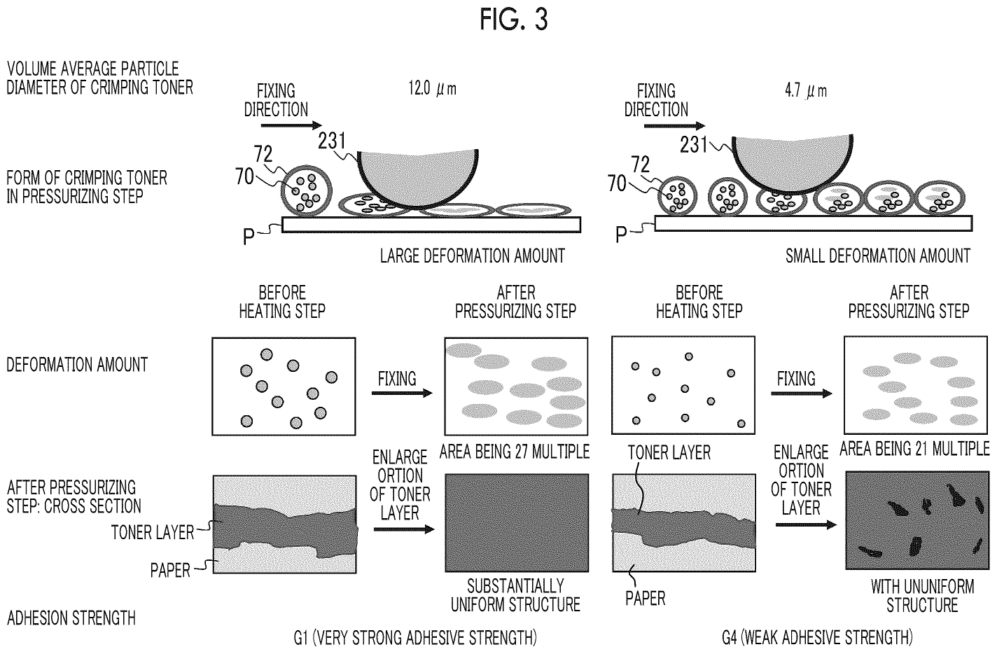

FIG. 3 shows a schematic view of the surface of the crimping toner in Examples 1 and 4 before the heating step and the pressurizing step, and a schematic view of the cross section after the heating step and the pressurizing step. FIG. 3 further shows a schematic view showing a form of the crimping toner in the pressurizing step.

As shown in FIG. 3, in a case where the adhesive strength is evaluated by causing the volume average particle diameter of the crimping toner 72 to differ, it is understood that the deformation amount of the layer of the crimping toner 72 is larger as the volume average particle diameter of the crimping toner 72 is increased, and the dispersion of the pressure plastic material 70 in the crimping toner layer is improved.

### Evaluation of Adhesive Strength

The tenth portion of the crimped printed matter is cut in the long side direction with a width of 15 mm to prepare a rectangular test piece, and the adhesive strength is evaluated for a region in which there is only the crimping toner on paper and a region in which the crimping toner is on the color toner. The evaluation of the adhesive strength is a subjective evaluation on a five-point scale by the subject, and the adhesive strength of the crimping toner is classified as follows. Regarding the adhesive strength of the crimping toner, the adhesive strength of G3 or higher (G1 to G3) is required in order to be used as a crimped printed matter such as a crimping postcard.

### Evaluation Criteria

G1: very strong adhesive strength
G2: strong adhesive strength
G3: normal adhesive strength
G4: weak adhesive strength
G5: very weak adhesive strength

TABLE 1

| | Volume Average | Volume Average | Adhesive Strength In | Adhesive Strength In |
|---|---|---|---|---|
| | Particle Diameter | Particle Diameter | Region In Which There | Region In Which |
| | Of Crimping Toner | Of Color Toner | Is Only Crimping Toner | Crimping Toner Is On |
| | [μm] | [μm] | On Paper | Color Toner |
| Example 1 | 4.7 | 4.7 | G4 | G4 |
| Example 2 | 6.0 | 4.7 | G3 | G3 |
| Example 3 | 9.0 | 4.7 | G1 | G2 |
| Example 4 | 12.0 | 4.7 | G1 | G1 |
| Example 5 | 4.7 | 5.8 | G4 | G5 |
| Example 6 | 6.0 | 5.8 | G3 | G3 |
| Example 7 | 9.0 | 5.8 | G1 | G3 |
| Example 8 | 12.0 | 5.8 | G1 | G2 |

As can be seen from Table 1, by increasing the volume average particle diameter of the crimping toner, the adhesive strength of the crimping toner is improved in both the region in which there is only the crimping toner on the paper and the region in which the crimping toner is on the color toner. In addition, it is understood that, by increasing the volume average particle diameter of the color toner, the adhesive strength in the region in which the crimping toner is on the color toner is lowered, and the volume average particle diameter of the color toner is becomes less than the volume average particle diameter of the crimping toner, and thus the adhesive strength that can be used for a crimped printed matter is obtained.

As described above, it is understood that, by using the crimping toner having a volume average particle diameter that is more than the volume average particle diameter of the color toner, the adhesive strength of the crimping toner is improved as compared with a case where the volume average particle diameter of the crimping toner is equal to or less than the volume average particle diameter of the color toner.

### Supplementary Notes

The present specification includes the following exemplary embodiments.

(((1)))

An image forming system comprising:
an image forming unit that forms an image on a recording medium by using a color toner;
an applying unit that applies a crimping toner having pressure-responsiveness onto at least a portion of a surface of the recording medium on which the image is formed;
a heating unit that heats the crimping toner applied to the recording medium; and
a pressurizing unit that pressurizes, in a thickness direction, a stacked body in which the recording medium is folded with the heated crimping toner interposed or a stacked body in which the recording medium and another medium are stacked with the heated crimping toner interposed,
wherein a volume average particle diameter of the crimping toner is more than a volume average particle diameter of the color toner.
   (((2)))

The image forming system according to (((1))),
wherein the volume average particle diameter of the crimping toner is more than 6 μm.
   (((3)))

The image forming system according to (((1))) or (((2))),
wherein the volume average particle diameter of the color toner is 6 μm or less.
   (((4)))

The image forming system according to any one of (((1))) to (((3))), further comprising:
a special color image forming unit that forms a special color image on the recording medium by using a special color toner,
wherein the volume average particle diameter of the crimping toner is less than a volume average particle diameter of the special color toner.
   (((5)))

The image forming system according to any one of (((1))) to (((4))),
wherein a toner mass (TMA) per unit area of the crimping toner is lower than TMA of the color toner.
   (((6)))

The image forming system according to (((5))),
wherein, in the image forming unit and the applying unit, TMA of the color toner and TMA of the crimping toner are controlled by a potential contrast in an electrostatic latent image on an image holding member.
   (((7)))

An image forming method comprising:
forming an image on a recording medium by using a color toner;
applying a crimping toner having pressure-responsiveness onto at least a portion of a surface of the recording medium on which the image is formed;
heating the crimping toner applied to the recording medium; and
pressurizing, in a thickness direction, a stacked body in which the recording medium is folded with the heated crimping toner interposed or a stacked body in which the recording medium and another medium are stacked with the heated crimping toner interposed,
wherein a volume average particle diameter of the crimping toner is more than a volume average particle diameter of the color toner.
   (((8)))

The image forming method according to (((7))),
wherein the volume average particle diameter of the crimping toner is 6 μm or more.
   (((9)))

The image forming method according to (((7))) or (((8))),
wherein the volume average particle diameter of the color toner is less than 6 μm.
   (((10)))

The image forming method according to any one of (((7))) to (((9))), further comprising:
forming a special color image on the recording medium by using a special color toner,
wherein the volume average particle diameter of the crimping toner is less than a volume average particle diameter of the special color toner.
   (((11)))

The image forming method according to any one of (((7))) to (((10))),
wherein a toner mass (TMA) per unit area of the crimping toner is lower than TMA of the color toner.
   (((12)))

The image forming method according to (((11))),
wherein, in the forming and the applying, TMA of the color toner and TMA of the crimping toner are controlled by a potential contrast in an electrostatic latent image on an image holding member.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming system comprising:
an image forming unit that forms an image on a recording medium by using a color toner;
an applying unit that applies a crimping toner having pressure-responsiveness onto at least a portion of a surface of the recording medium on which the image is formed;
a heating unit that heats the crimping toner applied to the recording medium; and
a pressurizing unit that pressurizes, in a thickness direction, a stacked body in which the recording medium is folded with the heated crimping toner interposed or a stacked body in which the recording medium and another medium are stacked with the heated crimping toner interposed,
wherein a volume average particle diameter of the crimping toner is more than a volume average particle diameter of the color toner.

2. The image forming system according to claim 1,
wherein the volume average particle diameter of the crimping toner is more than 6 μm.

3. The image forming system according to claim 1,
wherein the volume average particle diameter of the color toner is 6 μm or less.

4. The image forming system according to claim 2,
wherein the volume average particle diameter of the color toner is 6 μm or less.

5. The image forming system according to claim 1, further comprising:
a special color image forming unit that forms a special color image on the recording medium by using a special color toner,
wherein the volume average particle diameter of the crimping toner is less than a volume average particle diameter of the special color toner.

6. The image forming system according to claim 1,
wherein a toner mass (TMA) per unit area of the crimping toner is lower than TMA of the color toner.

7. The image forming system according to claim 2,
wherein a toner mass (TMA) per unit area of the crimping toner is lower than TMA of the color toner.

8. The image forming system according to claim 6,
wherein, in the image forming unit and the applying unit, TMA of the color toner and TMA of the crimping toner are controlled by a potential contrast in an electrostatic latent image on an image holding member.

9. The image forming system according to claim 7,
wherein, in the image forming unit and the applying unit, TMA of the color toner and TMA of the crimping toner are controlled by a potential contrast in an electrostatic latent image on an image holding member.

10. An image forming method comprising:
forming an image on a recording medium by using a color toner;
applying a crimping toner having pressure-responsiveness onto at least a portion of a surface of the recording medium on which the image is formed;
heating the crimping toner applied to the recording medium; and
pressurizing, in a thickness direction, a stacked body in which the recording medium is folded with the heated crimping toner interposed or a stacked body in which the recording medium and another medium are stacked with the heated crimping toner interposed,
wherein a volume average particle diameter of the crimping toner is more than a volume average particle diameter of the color toner.

11. The image forming method according to claim 10,
wherein the volume average particle diameter of the crimping toner is 6 μm or more.

12. The image forming method according to claim 10,
wherein the volume average particle diameter of the color toner is less than 6 μm.

13. The image forming method according to claim 11,
wherein the volume average particle diameter of the color toner is less than 6 μm.

14. The image forming method according to claim 10, further comprising:
forming a special color image on the recording medium by using a special color toner,
wherein the volume average particle diameter of the crimping toner is less than a volume average particle diameter of the special color toner.

15. The image forming method according to claim 10,
wherein a toner mass (TMA) per unit area of the crimping toner is lower than TMA of the color toner.

16. The image forming method according to claim 11,
wherein a toner mass (TMA) per unit area of the crimping toner is lower than TMA of the color toner.

17. The image forming method according to claim 15,
wherein, in the forming and the applying, TMA of the color toner and TMA of the crimping toner are controlled by a potential contrast in an electrostatic latent image on an image holding member.

18. The image forming method according to claim 16,
wherein, in the forming and the applying, TMA of the color toner and TMA of the crimping toner are controlled by a potential contrast in an electrostatic latent image on an image holding member.

19. A crimping toner image forming apparatus that disposes a color toner and a crimping toner that exerts functionality by deformation due to pressure, on a medium,
wherein a volume average particle diameter of the crimping toner is more than a volume average particle diameter of the color toner.
